(19) United States
(12) Patent Application Publication
(10) Pub. No.: US 2006/0149535 A1
(43) Pub. Date: Jul. 6, 2006

(54) Method for controlling speed of audio signals

(75) Inventors: Woo Young Choi, Seoul (KR); Hye Jeong Jeon, Seoul (KR)

Correspondence Address: JONATHAN T. KANG, ESQ.;LEE, HONG. DEGERMAN, KANG, & SCHMADEKA, 801 S. Figueroa Street, 14th Floor, Los Angeles, CA, 90017, US

(73) Assignee: LG Electronics Inc.

(21) Appl. No.: 11/321,583

(22) Filed: Dec. 28, 2005

(30) Foreign Application Priority Data
Dec. 30, 2004 (KR) 10-2004-0116893
Jan. 7, 2005 (KR) 10-2005-0001841

(51) Int. Cl. G10L 11/04

(52) U.S. Cl. 704/207

(57) ABSTRACT

A method for controlling the speed of audio signals is provided. The method is based on a TSM that uses an optimized AMDF and an OLA. According to the method, the number of frame sets is differently set depending a TSM speed rate to set the interval of a speed rate, and the number of frame sets required for adjusting the speed rate is determined. Subsequently, a TSM process is performed only when the TSM process is required for the frame set determined to adjust the speed rate, and speed processing is performed such that an input frame becomes an output frame otherwise.

Pursuant to 35 U.S.C. § 119(a), this application claims the benefit of earlier filing date and right of priority to Korean Patent Application Nos. 10-2004-0116893 and 10-2005-0001841 filed on Dec. 30, 2004 and Jan. 7, 2005 respectively, which are hereby incorporated by reference herein in their entirety.

### BACKGROUND OF THE INVENTION

1. Field of the Invention

The present invention relates to a method for controlling the speed of audio signals, capable of reproducing audio signals using a small amount of operations according to an accurate speed rate.

2. Description of the Related Art

An algorithm for controlling the speed of video or audio can be roughly divided into a sample recombination method and a processing method for each frame.

A representative sample recombination method is an up-sampling/down-sampling method, and a representative processing method for each frame is an overlap and add (OLA) and an SOLA algorithm proposed by Salim Roucos in 1985.

As illustrated in FIG. 1, the up-sampling/down sampling method requires a small amount of operations and is simple but considerably damages a tone color, so it is difficult to recognize voices under speed of 0.5x or 2.0x. On the contrary, the OLA and the SOLA algorithm, which are representative processing methods for each frame, do not damage a tone color very much, so they are more favored than the up-sampling/down-sampling method.

The OLA algorithm illustrated in FIG. 2 requires a small amount of operations and it is easy to recognize voices under the speed of 0.5x or 2.0x compared with the up-sampling/down-sampling, but it is difficult to actually apply the OLA algorithm to a product due to signal distortion. The SOLA algorithm proposed together with the OLA algorithm to solve the disadvantages of the OLA algorithm realizes excellent sound quality but requires a large amount of operations and so it is difficult to apply the SOLA algorithm to a real time time scale modification (TSM) system. A basic processing procedure of the SOLA algorithm is the same as that of the OLA algorithm, but the SOLA algorithm is different from the OLA algorithm in that the SOLA algorithm finds out a calculation equation for finding out a processing position of the OLA algorithm by comparing all of positions.

In detail, regarding the processing method for each frame of the TSM, there have been developed various algorithms such as a PSOLA for finding out the pitches of voices or audio signals and a WSOLA for finding out the similarity of signals to process an OLA, and many of them are currently under development.

The TSM, which an abbreviation of time scale modification, means an algorithm for controlling the speed of voices or music without a drastic change of a tone color.

The TSM may be applied to a variety of fields such as language study and broadcasting. Here, when a real-time TSM is required, the processing speed of the TSM is as important as a quality.

The TSM algorithm is currently actively commercialized for language study in an MP3 player and a personal computer (PC) program.

However, to actually apply the above algorithms to a product, it is required to provide a method for processing a high quality TSM in accordance with an accurate speed using a small amount of operations.

### SUMMARY OF THE INVENTION

Accordingly, the present invention is directed to a method for controlling the speed of audio signals that substantially obviates one or more problems due to limitations and disadvantages of the related art.

An object of the present invention is to provide a method for controlling the speed of audio signals, capable of creating a high quality TSM result using a small amount of operations in controlling the speed of audio signals in real-time.

Another object of the present invention is to provide a method for controlling the speed of audio frames, capable of accurately adjusting a desired speed in a TSM-based method for controlling the speed of audio signals using an optimized AMDF and an OLA, which are TSM methods in unit of a frame.

A further another object of the present invention is to provide a method for controlling the speed of audio frames, capable of solving a residue process section problem generated in a TSM algorithm using an optimized AMDF and an OLA, which are TSM methods in unit of a frame, and accurately adjusting a desired speed.

A still further another object of the present invention to provide a method for controlling the speed of audio frames, capable of determining the interval of speed rates by differently setting the number of frame sets according to the speed rate of a TSM in a TSM-based voice/audio speed changing/reproducing method that uses an optimized AMDF and an OLA, which are TSM methods in unit of a frame, and accurately adjusting a desired speed.

An even further another object of the present invention is to provide a method for controlling the speed of audio frames, capable of adding a residue process section to a next input frame and processing the same and accurately adjusting a desired speed in order to a problem of a residue process section of about 2xPmax (maximum pitch setting) at the maximum generated when a TSM-based voice/audio speed changing/reproducing method that uses an optimized AMDF and an OLA, which are TSM methods in unit of a frame, performs a TSM in unit of a frame.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a TSM-based method for controlling the speed of audio signals using an optimized absolute magnitude difference function (AMDF) and an OLA, the method including: differently setting the number of frame sets depending on a TSM speed rate to set the interval of a speed rate; determining the number of frame sets to be TSM-processed so as to adjust the speed rate; and performing TSM process only when the TSM process is required for the frame set determined to adjust the speed rate, and performing speed processing such that an input frame becomes an output frame otherwise.

In another aspect of the present invention, there is provided a method for controlling the speed of audio signals, the method including: reading a sample of an audio file; searching/comparing pitches from a predetermined pitch search range; and increasing or reducing the pitches depending on a speed rate, wherein the pitch search range is in a range between Pmax and Pmin, the Pmax has a value of 25/3x (sample rate/1000), and the Pmin has a value of 5/3x (sample rate/1000).

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating an up-sampling/down-sampling, which is one of the related art methods for controlling the speed of voices and audio signals;

FIG. 2 is a view illustrating an OLA method, which is one of the related art methods for controlling the speed of voices and audio signals;

FIG. 3 is a flowchart of a method for controlling the speed of voices and audio signals according to the sprint of the present invention;

FIG. 4 is a view of a method for adjusting a speed rate using a frame set according to the present invention;

FIG. 5 is a flowchart of a method for adjusting a speed rate using a frame set according to the present invention;

FIG. 6 is a view illustrating an example of accumulation of residue process sections according to the present invention;

FIG. 7 is a view illustrating an example of a method solving a residue process section accumulation problem through buffering according to the present invention; and

FIG. 8 is a view illustrating an example of buffering and compensation for processing various speed rates according to the present invention.

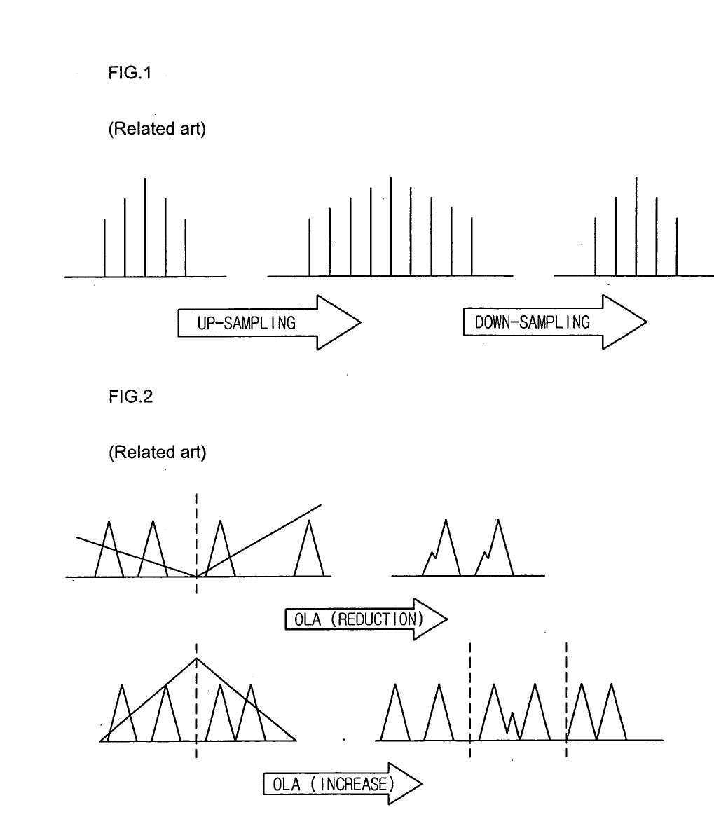

### DETAILED DESCRIPTION OF THE INVENTION

Reference will now be made in detail to the preferred embodiments of the present invention, examples of which are illustrated in the accompanying drawings.

### First Embodiment

The present invention provides a method for controlling the speed of audio signals, capable of reducing an amount of operations as much as possible so that a real-time audio speed control may be applied to any system, and not having an influence on a quality.

For example, the present invention may be applied to a language function of an MP3 player and a cellular phone, and a time shift function of a digital television (TV).

A basic pitch of a voice may be found in the range of 100 Hz-650 Hz, which means that a search range of the pitch may be set between a Pmin (5/3x (sample rate/1000) and a Pmax (25/3x (sample rate/1000). A method of reducing a pitch search range to perform an AMDF is generally used for speech.

Here, for accuracy, the pitch search range may be readily increased to process an AMDF, and a more increased pitch search range may be determined depending on cases. However, increasing the pitch search range may be a factor that increases an amount of AMDF operations, so that it is preferable to use the above-defined range except a particular case. The AMDF will be described in detail below.

The present invention processes the speed of voices and music within a short time by applying a pitch search algorithm optimized for the pitch of voice signals since voice signals more sensitively react to a processing speed than music does.

A basic pitch search algorithm used by the present invention is an AMDF, which is one of algorithms having a smallest operation amount among various pitch search algorithms including an autocorrelation method.

When a sound source is damaged, pitch information of a previous frame is required to obtain a residual signal, which is a difference between a real value and an estimated value of the damaged sound source. The AMDF is used to obtain the pitch.
C(P)=Σ|S(i)−S(P+i)|(from i=0 to i=P)i+=1

This is an equation expressing the AMDF. The S(i) means the value of a voice sample of a buffer. As known from the equation, it is possible to easily obtain a pitch through simple operations of addition and subtraction.

In more detail, a value of P that minimizes a value of C(P) becomes a pitch of a sound source sample. However, since the C(P) has a large value as i increases due to the sigma operation, an operation of dividing using the number of pitches should be performed to obtain a correct C(P) value. The operation of dividing requires a considerable amount of operations, which is problematic.

That is, such a simple mathematical operation should process lots of samples to realize a TSM in real-time, and thus requires a great amount of operations, which inevitably delays a processing speed.
C(P)=Σ|S(i)−S(P+i)|(from i=0 to i=Pavg)i+=Pavg/6

This is an equation expressing an AMDF algorithm according to the sprit of the present invention. The present invention provides an efficient pitch search method by optimizing the related art AMDF algorithm using the equation illustrated above. The optimized AMDF method according to the present invention remarkably reduces an amount of operations while maintaining the quality of basic pitch search required for a TSM by minimizing the range and the interval of a comparison sample while maintaining the equation of the related art AMDF.

In more detail, according to the optimized AMDF method, a process of subtracting a sound source sample size of a pitch interval is performed as much as a Pavg regardless of a pitch size, so that a dividing operation, which should be performed when the related art AMDF is performed, dose not need to be performed.

In more detail, to obtain the minimum value of C(P) according to a value of a pitch in the related art, a value of C(P) should be divided by the value of the pitch to calculate an accurate pitch. However, according to the present invention, addition and subtraction operations as much as Pavg are performed regardless of Pmax and Pmim, so that the value of C(P) may be founded without the dividing operation.

Also, the related art AMDF algorithm has performed an operation while uniformly increasing a value i by one. On the contrary, the present invention performs an operation while skipping the operation as much as the number obtained by dividing the Pavg by a predetermined number, so that an operation speed increases.

For example, when finding the pitch while increasing a value I as much as Pavg/6, the number of times of operations performed for finding the minimum value of C(P) is remarkably reduced, which reduces an amount of operations and improves a processing speed.

The optimized AMDF, which is one of characteristics of the present invention, is used as an algorithm that finds a pitch in a TSM. The AMDF according to the present invention reduces an amount of operations by controlling a search range, a comparison range, and a comparison interval of a pitch in the equation of the related art AMDF and thus remarkably improves a processing speed.

The search range of the pitch is in a range between Pmax and Pmin as described above. Though the Pmax and the Pmin may have various values depending on definition, it is preferable that the Pmax has a value of 25/3x (sample rate/1000) and the Pmin has a value of 5/3x (sample rate/1000) to reduce an amount of operations.

It is preferable to make exact comparison using all of the numbers of pitches that a user desires to find when determining a comparison range of a pitch used for an AMDF, but a consistent comparison range is required to make overall comparison of the number of pitches used in each of operations.

That is, the related art can make exact comparison by dividing each of C(P) values by the number of pitches when searching a minimum AMDF value. However, the present invention defines the Pavg as the size of the comparison range, thereby allowing AMDF values to be compared without a dividing operation. As a preferred embodiment of the present invention, it is possible to reduce an amount of operations by defining the Pavg as 5x (sample rate/1000).

The reason of finding the pitch by performing the AMDF mainly on voices is that the voices more sensitively react to even small signal distortion during the TSM than music does. Also, most of the speed control function is performed mainly on the voices.

However, it is not considered that the TSM mainly applied for the voices has a negative effect on a TSM for music because even when a search range of a pitch is reduced to a range of voices, the search range still has so large amount of operations considering a time required for decoding codec used before the TSM to operate the TSM in real-time for the searching of the pitch.

The present invention has realized a method of realizing an AMDF required for a TSM through a minimum amount of operation. For that purpose, a comparison interval is defined using a delta value, not 1 sample interval to perform an operation. According to an embodiment of the present invention, the delta value may be Pavg/6. When the Pavg value is defined using 5x (sample rate/1000), which is a value according to an embodiment of the present invention, the delta value may be defined using 5/6x (sample rate/1000). It is possible to reduce a tremendous amount of sample comparisons and optimize an amount of operations by defining the delta value.

For example, assuming that a sampling rate is 48 kHz, a delta value may be 5/6x (48000/1000)=40 and Pavg may be 5x (sample rate/1000)=240. In that case, when a delta value is not applied and i is increased by one to calculate AMDF values, 240 times of subtraction and addition operations should be performed. However, when the delta value is used, only six times of subtraction and addition operations are required, so that an amount of operations is reduced to one fortieth.

When an amount of operations should be further reduced, the delta value is defined using Pavg/α. That is, the delta value is expressed by 5/αx (sample rate/1000). α may be a value between 2 and 5. However, since signal distortion increases as α is reduced, it is preferable to use α greater than 6.

According to the present invention, it is possible to reproduce a more natural recovered sound by OLA-processing a pitch value through application of a PSOLA concept.

That is, the present invention applies a method of finding a pitch value or a predetermined range having a difference of minimum samples through the above-described optimized AMDF method, and OLA-processing the pitch value or the predetermined range to add or reduce as much as the pitch value or a predetermined range.

It is possible to control the speed of voices and music in a range from 0.5x to 2.0x without damage of a tone color by repeatedly performing the above processes. A speed rate between 0.5x and 1.0x and between 1.0x and 2.0x may be controlled by defining the number of frames required to perform the AMDF and OLA once.

Such an operation will be described in more detail below. The present invention is based on a basic algorithm of the PSOLA but has a characteristic of being easily commercialized by proposing and applying the optimized AMDF.

According to the present invention, it is possible to find the position of a pitch or a minimum AMDF value to reduce the pitch from two to one or increase the pitch from two to three using an OLA algorithm. Also, it is possible to freely control a speed rate by determining how frequently the reduction and the increase are performed in unit of a frame.

A method of setting a speed of 1.7x is considered for example. When applying the optimized AMDF and OLA to seven frames of ten frames to perform reduction, the speed rate of 1.7x may be approximately achieved.

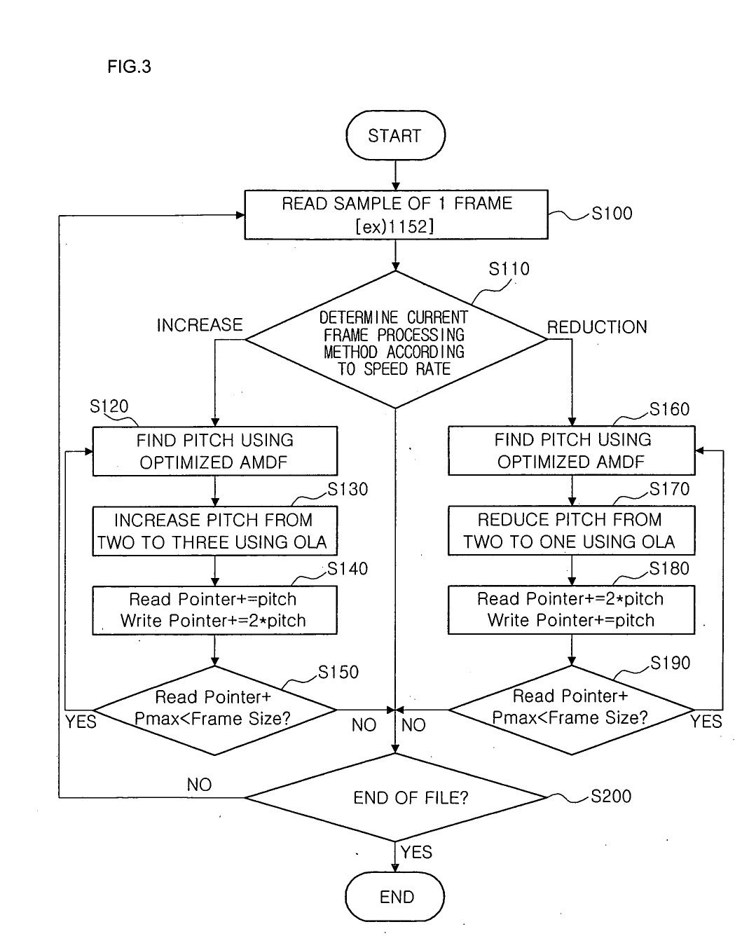

The range of the speed rate is between 0.5x and 2.0x. The speed rate of 0.5x may be achieved when the optimized AMDF and OLA are set to perform increase for all of frames. The speed rate of 2.0x may be achieved when the optimized AMDF and OLA are set to perform reduction for all of frames. A process of performing the optimized AMDF and OLA is illustrated in FIG. 3, which will be described in detail below.

FIG. 3 is a flowchart of a method for controlling the speed of voices and audio signals according to the sprint of the present invention.

Referring to FIG. 3, a sample in unit of a frame from a file, a speed of which a user desires to control, is read from an audio speed controller (S100). Since AMDF and OLA methods change according to a processing method of the frame recognized in the above operation, the processing method of the frame according to a speed rate is determined (S110). The processing methods include increase of the frame, reduction of the frame, and invariance of the frame.

First, the increase of the frame will be considered. Optimized pitches are using an optimized AMDF (S120). Next, two pitches searched in the above operation are increased into three pitches using an OLA (S130). A reader pointer reads a sample as much as an increment that increases by one pitch, and a writer point stores the increased pitch, i.e., the samples that correspond to two pitches in a buffer using the pitches read by the read pointer and the OLA (S140).

Next, a sum of the length of the sample accumulated in the read pointer and a Pmax is compared with the size of a frame (S150). When the sum of the length of the sample accumulated in the read pointer and the Pmax is smaller than the size of the frame as a result of the comparison, the operation S120 is performed again to search a pitch using an optimized AMDF. ON the contrary, when the sum is grater than the size of the sample, which means that it is an end of the frame, a new frame should be searched.

Whether it is an end of the file is judged before a new frame is searched (S200). When a file a user desires to increase does not exist, the frame processing method is ended. When the file exists, the operation S100 is performed to search for a new frame.

When the speed rate is invariant in the operation S110, increase and reduction of the frame are not required, so only whether it is an end of a file is judged in the operation S200.

When the speed rate is reduced in the operation S110, a pitch is searched using the optimized AMDF (S160) as in the case where the speed rate is increased, and two pitches are reduced into one pitch using the OLA (S170). The read pointer samples as much as the two pitches, and the writer pointer stores the samples that correspond to one pitch in the buffer (S180).

After that, when the sum of the length of the sample accumulated in the read pointer and the Pmax is smaller than the size of the frame as in the operation S150, the operation S160 is performed, otherwise, whether it is the end of the file is judged (S200). When the file is ended in the operation S200, the above processes are all ended; otherwise, a new frame is searched.

### Second Embodiment

A method for controlling the speed of audio signals according to the second embodiment of the present invention will be described with reference to the accompanying drawings.

The characteristics of the present invention include a method of setting S operations reproducing slowly and F operations reproducing fast, and a TSM processing method according to a speed rate. First, S and F should have the same value. It is assumed that setting values S and F are N. Here, N may be any finite value equal to or greater than 1. A control interval of a speed rate that reproduces slowly is 0.5/N and a control interval of a speed rate that reproduces fast is 1.0/N.

For example, assuming that N is 5, the control interval of the speed rate that reproduces slowly is 0.1 (=0.5/5) and the control interval of the speed rate that reproduces fast is 0.2 (1.0/5). Therefore, speed rates that can be set are 0.5, 0.6, 0.7, 0.8, 0.9, 1.2, 1.4, 1.6, 1.8, and 2.0.

As described above, the control interval of the speed rate may be made small by increasing the value of N. When performing the TSM using the optimized AMDF and OLA method, it is difficult to control as the speed rates are made into speed rates of minute intervals. The present invention manages the speed rates by determining the number of frame sets to be TSM-processed from N frame sets so as to easily manage an algorithm.

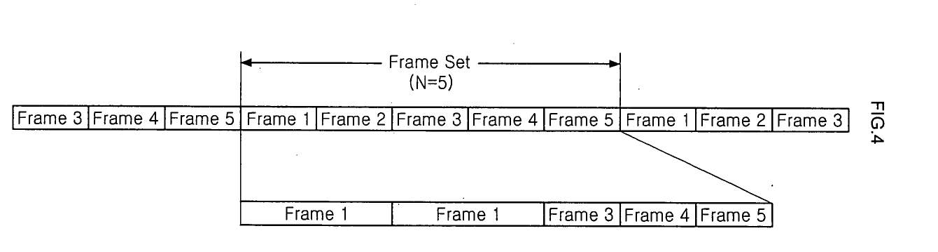

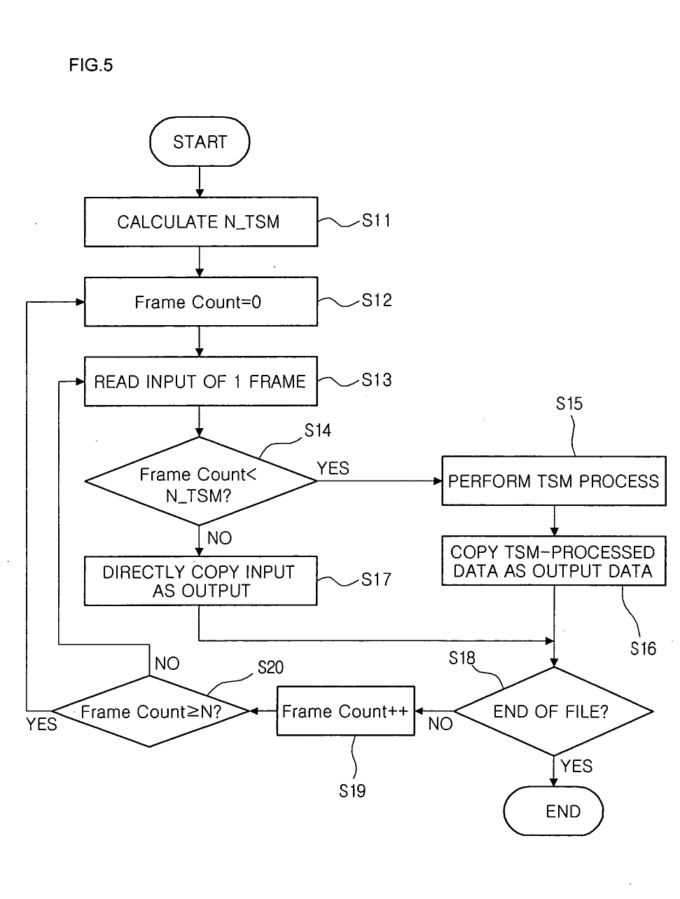

FIG. 4 illustrates how the speed rate of 0.8x is realized using the above-described method. Referring to FIG. 4, the number of frames to be TSM-processed is determined as |0.8−1|/(0.1) by an equation of |speed−1|/(speed interval), and a speed rate process is performed on a relevant frame. That is, a TSM increase is applied for two frames of a frame 1 and a frame 2.

FIG. 5 is a flowchart of a method for adjusting a speed rate using a frame set according to the present invention.

In an operation S11, a N TSM is calculated to control a TSM-based speed rate as described above. Next, a frame count is initialized at ‘0’ (S12) and an input of a frame 1 is read (S13).

Next, the frame count is compared with the calculated N TSM (S14). When the frame count is smaller than the N TSM as a result of the comparison, an operation S15 is performed to TSM-process a relevant frame and then the TSM-processed frame is copied as an output (S16).

After that, an operation S18 is performed to judge whether it is an end of a file. When it is the end of the file, the whole process is ended, otherwise, an operation S19 is performed to increase the frame count and subsequently the frame count is compared with a value of N (S20). When the frame count is smaller than N, an operation S13 of reading an input of a next frame 1 is performed. When the frame count is greater than N, an operation S12 of initializing the frame count at ‘0’ is performed.

When the frame count is greater than the N TSM in the operation S14, an operation S17 is performed to directly copy an input as an output, and then the operation S18 is performed to judge whether it is an end of the file. When it is the end of the file, the whole process is ended, otherwise, the operation S19 is performed to increase the frame count and allow the above processes to be repeatedly performed on a next frame.

As described above, it is possible to determine the interval of the speed rate by differently setting the number of frame sets depending on the speed rate of the TSM, and determine the number of frames to be TSM-processed so as to adjust the speed rate, so that the TSM process is performed only when necessary (S15) and an input frame becomes an output frame as it is (S17).

The present invention also solves the problem that the optimized AMDF and OLA cannot process an error of the speed rate generated in a residue process section. The present invention proposes several processing methods to solve the problem while maintaining the above described advantages.

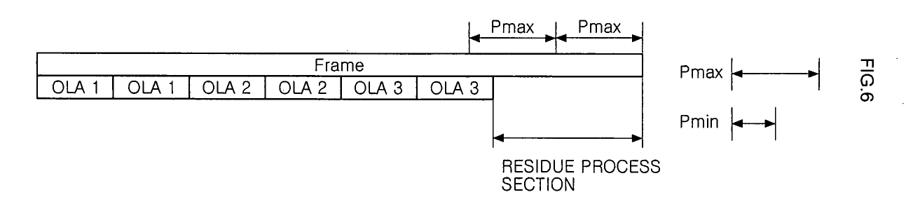

When the optimized AMDF and OLA is used, residue process sections that correspond to two times a Pmax, 25/3x (sample rate/1000) at the maximum may be generated per frame. An example of this phenomenon is illustrated in FIG. 6. Referring to FIG. 6, it is known that a residue process section as much as 2xPmax at the maximum may be generated for a relevant audio frame when compression or expansion for a speed rate control is performed on the basis of a TSM.

Buffering is performed between the frames to process this residue process section.

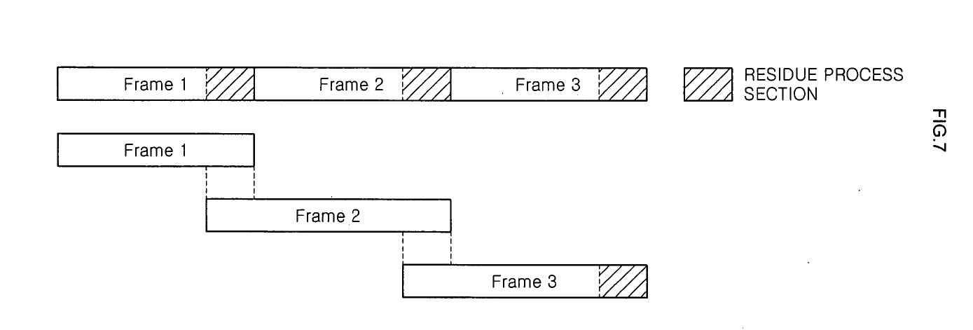

A buffering method is schematically illustrated in FIG. 7. Here, the buffering means adding the residue process section to a next input frame and process the same together. Referring to FIG. 7, it is known that a residue process section of a frame 1 is added to a frame 2 and processed together and that a residue process section of the frame 2 is added to a frame 3 and processed together. By doing so, accumulation of the residue process sections is prevented, and an amount of 2xPmax at the maximum generated in a last frame when the TSM is ended may be processed using a simple OLA.

When the TSM is performed without the buffering, the residue process sections are gradually accumulated and may be a considerably large amount later. On the contrary, since the residue process section is maintained as much as 2xPmax at the maximum in real-time when the buffering is performed, the 2xPmax at the maximum generated at a last frame when the TSM is ended may be processed using a simple OLA process.

Here, a case where the speed rate is 0.5 or 2.0 will be considered. In that case, a little more process in addition to the buffering is further required. Assuming that a next frame is a frame where a TSM process is not required with a residue process section left, a residue process section of 2xPmax at the maximum may be generated in a frame set, the size of a total residue process section may gradually increase. To solve this problem, another compensation process is required to process a case where frames that require the TSM process are not continuous.

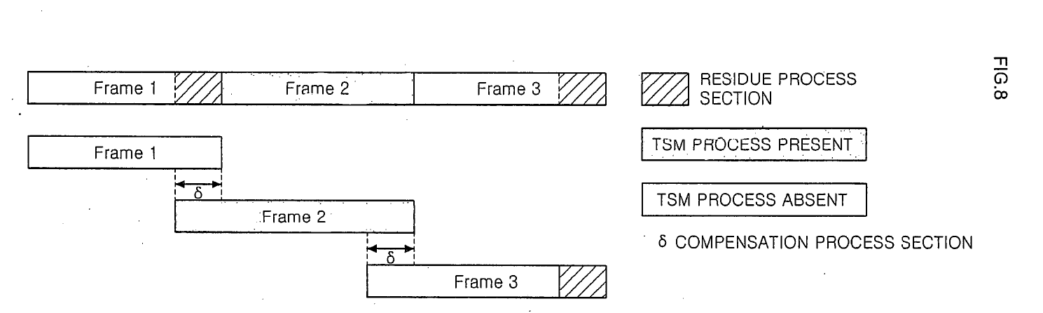

For example, in a case of the speed rate of 0.8x, only first two frames of total ten frame sets are TSM-processed and the other eight frames are not TSM-processed. The buffering and the compensation algorithm should be included during various speed rate processes. The concept of the above process is illustrated in detail in FIG. 8.

Referring to FIG. 8, a frame 2 is not TSM-processed and a TSM buffering non-continuous section is generated due to the frame 2. The TSM buffering non-continuous section is left as a residue process section, which is illustrated by δ in FIG. 8. The δ is used as a compensation section δ in a next TSM section (frame 3), so that as much as a last δ of a last frame in a frame set is included in a next TSM section, which allows accurate buffering to be performed even for various speed rates.

The present invention provides high quality TSM results using a small amount of operations when controlling the speed of voices and music in real-time.

Also, according to the present invention, the optimized AMDF and OLA may be ported in a normal way to a TSM module after decoding is performed at various embedded products.

The embedded products include digital televisions, MP3 players, and cellular phones. All of these products process audio signals (or video/audio signals) using a decoder. The present invention has a great advantage of accurately processing various speed rates without reducing quality in a TSM process in unit of a frame.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A time scale modification (TSM)-based method for controlling the speed of audio signals using an optimized absolute magnitude difference function (AMDF) and an overlap and add (OLA), the method comprising:
differently setting the number of frame sets depending on a TSM speed rate to set the interval of a speed rate;
determining the number of frame sets to be TSM-processed so as to adjust the speed rate; and
performing a TSM process only when the TSM process is required for the frame set determined to adjust the speed rate, and performing speed processing such that an input frame becomes an output frame otherwise.

2. The method according to claim 1, wherein a residue process section is added to a next input frame and processed together when the TSM is performed in unit of a frame.

3. The method according to claim 1, wherein a TSM increase is applied to reproduce slowly when the speed rate is smaller than 1, and a TSM reduction is applied to reproduce fast when the speed rate is greater than 1.

4. The method according to claim 1, wherein S operations for reproducing slowly and F operations for reproducing fast are set at the same value of N in the speed rate, a control interval of a speed rate that reproduces slowly is 0.5/N, and a control interval of a speed rate that reproduces fast is 1.0/N.

5. The method according to claim 4, wherein the control interval of the speed rate is made smaller by increasing the N, and the control interval of the speed rate is made larger by reducing the N.

6. The method according to claim 1, wherein the speed rate is managed by determining the number of frames to be TSM-processed among N frame sets.

7. The method according to claim 1, wherein buffering is performed between frames to prevent residue process sections generated during TSM-based audio frame speed control from being accumulated.

8. The method according to claim 1, wherein buffering is performed between frames to process residue process sections generated during TSM-based audio frame speed control, so that the residue process section is maintained as much as 2xPmax at the maximum in real-time.

9. The method according to claim 1, wherein buffering is performed between frames to process residue process sections generated during TSM-based audio frame speed control, so that the residue process section is maintained as much as 2xPmax at the maximum in real-time, and 2xPmax generated at the maximum in a last frame when the TSM is ended is OLA-processed.

10. The method according to claim 7, wherein when a frame that requires TSM process is not continuous and a buffering non-continuous section is generated, the buffering non-continuous section is used as a compensation section in a next TSM section, and as much as a last non-continuous section of a last frame in a frame set is included in a next TSM section.

11. A method for controlling the speed of audio signals, the method comprising:
reading a sample of an audio file;
searching/comparing pitches from a predetermined pitch search range; and
increasing or reducing the pitches depending on a speed rate,
wherein the pitch search range is in a range between Pmax and Pmin, the Pmax has a value of 25/3x (sample rate/1000), and the Pmin has a value of 5/3x (sample rate/1000).

12. The method according to claim 11, wherein the searching/comparing of the pitches comprises applying an algorithm to pitches of voice signals.

13. The method according to claim 11, wherein the comparing of the pitches comprises addition and subtraction operations.

14. The method according to claim 11, wherein the comparison of the pitches are performed as much as Pavg regardless of the pitch's size.

15. The method according to claim 14, wherein a value of the Pavg is defined as 5x (sample rate/1000).

16. The method according to claim 11, wherein the comparison is performed by applying a delta value defined by Pavg/α for an interval of the comparison of the pitches, α being equal to or greater than 6.
